(19) United States
(12) Patent Application Publication
(10) Pub. No.: US 2022/0079279 A1
(43) Pub. Date: Mar. 17, 2022

(54) Multi Layer Protective Helmet

(71) Applicant: M. Hassan Hassan, Windermere, FL (US)

(72) Inventor: M. Hassan Hassan, Windermere, FL (US)

(21) Appl. No.: 17/021,512

(22) Filed: Sep. 15, 2020

(51) Int. Cl. A42B 3/06; A42B 3/12; A42B 3/20; B32B 1/00; B32B 3/14; B32B 5/18

(52) U.S. Cl. CPC A42B 3/063; A42B 3/125; A42B 3/205; B32B 2437/04; B32B 3/14; B32B 5/18; B32B 2571/02; B32B 1/00

(57) ABSTRACT

A multi layer protective helmet has: a shell with inner surface and outer surface; at least one inner energy absorbing layer coupled to the inner surface of the shell; and at least one outer energy absorbing layer coupled to the outer surface of the shell. The outermost energy absorbing layer is a hair-like layer whereas each hair represents a spring-like element capable of deforming when force is applied then returning to its state prior to application of the force. The innermost energy absorbing layer has a contoured member to conform to the general outline of a wearer's head. In addition, the shell layer is integrated with energy absorbing material spaced within the structure of the shell to dampen the impact of energy further.

### CROSS REFERENCE TO RELATED APPLICATIONS

This application claims the benefit of provisional patent application Ser. No. 62/953,693, filed 2019 Dec. 26 by the present inventor.

### REFERENCES CITED

The following is a tabulation of some prior art that presently appears relevant:

### U.S. Patent Documents

| U.S. Pat No. 3,784,984 | Aileo | Jan. 15, 1974 |
|---|---|---|
| U.S. Pat No. 3,786,519 | Aileo | Jan. 22, 1974 |
| U.S. Pat No. 3,789,427 | Aileo | Feb. 5, 1974 |
| U.S. Pat No. 3,797,039 | Penberthy | Mar. 19, 1974 |
| U.S. Pat No. 3,806,950 | Spencer-Foote | Apr. 30, 1974 |
| U.S. Pat No. 3,834,379 | Grant | Sep. 10, 1974 |
| U.S. Pat No. 3,943,572 | Aileo | Mar. 16, 1976 |
| U.S. Pat No. 3,946,441 | Johnson | Mar. 30, 1976 |
| U.S. Pat No. 4,024,587 | Barford | May 24, 1977 |
| U.S. Pat No. 4,035,845 | Hochwalt | Jul. 19, 1977 |
| U.S. Pat No. 4,064,565 | Griffiths | Dec. 27, 1977 |
| U.S. Pat No. 4,287,613 | Schulz | Sep. 8, 1981 |
| U.S. Pat No. 4,290,150 | Guerre-Berthelot | Sep. 22, 1981 |
| U.S. Pat No. 4,343,047 | Lazowski, et al. | Aug. 10, 1982 |
| U.S. Pat No. 4,345,338 | Frieder, Jr., et al. | Aug. 24, 1982 |
| U.S. Pat No. 4,375,108 | Gooding | Mar. 1, 1983 |
| U.S. Pat No. 4,412,358 | Lavender | Nov. 1, 1983 |
| U.S. Pat No. 4,504,604 | Pilkington, et al. | Mar. 12, 1985 |
| U.S. Pat No. 4,519,099 | Kamiya, et al. | May 28, 1985 |
| U.S. Pat No. 4,808,469 | Hiles | Feb. 28, 1989 |
| U.S. Pat No. 4,843,642 | Brower | Jul. 4, 1989 |
| U.S. Pat No. 4,845,786 | Chiarella | Jul. 11, 1989 |
| U.S. Pat No. 5,014,365 | Schulz | May 14, 1991 |
| U.S. Pat No. 5,056,162 | Tirums | Oct. 15, 1991 |
| U.S. Pat No. 5,083,321 | Davidsson | Jan. 28, 1992 |
| U.S. Pat No. 5,522,091 | Rudolf | Jun. 4, 1996 |
| U.S. Pat No. 5,544,367 | March, II | Aug. 13, 1996 |
| U.S. Pat No. 5,553,330 | Carveth | Sep. 10, 1996 |
| U.S. Pat No. 5,743,621 | Mantha, et al. | Apr. 28, 1998 |
| U.S. Pat No. 5,809,578 | Williams | Sep. 22, 1998 |
| U.S. Pat No. 5,856,811 | Shih, et al. | Jan. 5, 1999 |
| U.S. Pat No. 5,947,515 | Fitch | Sep. 7, 1999 |
| U.S. Pat No. 5,947,918 | Jones, et al. | Sep. 7, 1999 |
| U.S. Pat No. 6,070,271 | Williams | Jun. 6, 2000 |
| U.S. Pat No. 6,154,889 | Moore, III, et al. | Dec. 5, 2000 |
| U.S. Pat No. 6,381,758 | Roberts, II, et al. | May 7, 2002 |
| U.S. Pat No. 6,425,141 | Ewing, et al. | Jul. 30, 2002 |
| U.S. Pat No. 6,453,476 | Moore, III | Sep. 24, 2002 |
| U.S. Pat No. 6,536,052 | Tao, et al. | Mar. 25, 2003 |
| U.S. Pat No. 6,658,671 | Von Holst, et al. | Dec. 9, 2003 |
| U.S. Pat No. 6,751,809 | Cooper, et al. | Jun. 22, 2004 |
| U.S. Pat No. 6,931,671 | Skiba | Aug. 23, 2005 |
| U.S. Pat No. 6,962,235 | Leon | Nov. 8, 2005 |
| U.S. Pat No. 7,062,795 | Skiba, et al. | Jun. 20, 2006 |
| U.S. Pat No. 7,520,559 | Vo, et al. | Apr. 21, 2009 |
| U.S. Pat No. 7,832,023 | Crisco | Nov. 16, 2010 |
| U.S. Pat No. 7,904,971 | Doria, et al. | Mar. 15,2011 |
| U.S. Pat No. 7,931,963 | Maurer, et al. | Apr. 26, 2011 |
| U.S. Pat No. 7,794,827 | Palmer, et al. | Sep. 14, 2010 |
| U.S. Pat No. 7,988,313 | Kutnyak | Aug. 2, 2011 |
| U.S. Pat No. 8,016,350 | Dellanno | Sep. 13, 2011 |
| U.S. Pat No. 8,020,220 | McElroy, et al. | Sep. 20, 2011 |
| U.S. Pat No. 8,039,078 | Moore, III, et al. | Oct. 18, 2011 |
| U.S. Pat No. 8,092,727 | Maurer, et al. | Jan. 10, 2012 |
| U.S. Pat No. 8,156,569 | Cripton, et al. | Apr. 17, 2012 |
| U.S. Pat No. 8,182,909 | Schneider, et al. | May 22, 2012 |
| U.S. Pat No. 8,296,863 | Cripton, et al. | Oct. 30, 2012 |
| U.S. Pat No. 8,399,085 | Moore, III, et al. | Mar. 19, 2013 |
| U.S. Pat No. 8,533,869 | Capuano | Sep. 17, 2013 |
| U.S. Pat No. 8,578,520 | Halldin | Nov. 12, 2013 |
| U.S. Pat No. 8,883,869 | Schofalvi, et al. | Nov. 11, 2014 |
| U.S. Pat No. 9,119,433 | Leon | Sep. 1, 2015 |
| U.S. Pat No. 9,155,924 | Grove, et al. | Oct. 13, 2015 |
| U.S. Pat No. 9,185,945 | Rietdyk | Nov. 17, 2015 |
| U.S. Pat No. 9,316,282 | Harris | Apr. 19, 2016 |
| U.S. Pat No. 9,414,632 | Dougherty, et al. | Aug. 16, 2016 |
| U.S. Pat No. 9,420,843 | Cormier, et al. | Aug. 23, 2016 |
| U.S. Pat No. 9,428,130 | Klausmann, et al. | Aug. 30, 2016 |
| U.S. Pat No. 9,462,843 | Cormier, et al. | Oct. 11, 2016 |
| U.S. Pat No. 9,468,248 | Leon | Oct. 18, 2016 |
| U.S. Pat No. 9,498,014 | Princip, et al. | Nov. 22, 2016 |
| U.S. Pat No. 9,549,583 | Pietrzak, et al. | Jan. 24, 2017 |
| U.S. Pat No. 9,554,608 | Leon | Jan. 31, 2017 |
| U.S. Pat No. 9,560,892 | Leon | Feb. 7, 2017 |
| U.S. Pat No. 9,572,390 | Simpson | Feb. 21, 2017 |
| U.S. Pat No. 9,603,406 | Halldin | Mar. 28, 2017 |
| U.S. Pat No. 9,603,408 | Simpson | Mar. 28, 2017 |
| U.S. Pat No. 9,622,534 | Cormier, et al. | Apr. 18, 2017 |
| U.S. Pat No. 9,674,409 | Jones | Jun. 6, 2017 |
| U.S. Pat No. 9,788,589 | Lewis, et al. | Oct. 17, 2017 |
| U.S. Pat No. 9,795,180 | Lowe, et al. | Oct. 24, 2017 |
| U.S. Pat No. 9,833,032 | Jacobsen | Dec. 5, 2017 |
| U.S. Pat No. 9,861,152 | Rumfelt | Jan. 9, 2018 |
| U.S. Pat No. 9,883,709 | Penner, et al. | Feb. 6, 2018 |
| U.S. Pat No. 9,907,347 | Allen | Mar. 6, 2018 |
| U.S. Pat No. 9,955,049 | Pritz | Apr. 24, 2018 |
| U.S. Pat No. 9,955,745 | Halldin | May 1, 2018 |
| 10,016,007 | Jacobsen | Jul. 10, 2018 |
| 10,092,055 | Hector, Jr., et al. | Oct. 9, 2018 |
| 10,092,057 | Kovarik, et al. | Oct. 9, 2018 |
| 10,098,402 | Booher, Sr., et al. | Oct. 16, 2018 |
| 10,130,133 | Leon | Nov. 20, 2018 |
| 10,178,888 | Wetzel, et al. | Jan. 15, 2019 |
| 10,201,743 | Simpson | Feb. 12, 2019 |
| 10,212,979 | Halldin | Feb. 26, 2019 |
| 10,285,466 | Princip, et al. | May 14, 2019 |
| 10,307,295 | Lloyd, et al. | Jun. 4, 2019 |
| 10,376,010 | Allen, et al. | Aug. 13, 2019 |
| 10,419,655 | Sivan | Sep. 17, 2019 |
| 10,444,099 | Sicking | Oct. 15, 2019 |
| 10,448,691 | Princip, et al. | Oct. 22, 2019 |
| 10,470,514 | Princip, et al. | Nov. 12, 2019 |
| 10,470,515 | Princip, et al. | Nov. 12, 2019 |
| 10,492,559 | Kele, et al. | Dec. 3, 2019 |

### DESCRIPTION

### Field of the Invention

The present invention relates generally to any protective helmet, and more particularly a helmet for use in sports such as American football, lacrosse, hockey, baseball, motor cycling or bicycling; and a helmet used in workplaces such as construction sites and industrial plants.

### Description of the Related Art

Helmets and other protective headgear are commonly utilized to protect a wearer's head from injury. Typically, helmets are designed specifically for the particular sport or activity. Numerous sports, such as American football, hockey, and lacrosse, require players to wear helmets. Helmets are also recommended for motor cycling, bicycling, and hazardous workplaces and industrial plants.

American football helmets have evolved since the inception of football. In the early years of football, football players did not wear helmets or protective headgear. As the number of football player head injuries increased, helmets became a required item of equipment. One of the first instances of football headgear dates to 1896 when Lafayette College halfback George “Rose” Barclay began to use straps and earpieces to protect his ears.

The football helmet used prior to World War II was primarily a leather cap with ear flaps. Subsequent to World War II, a football helmet was introduced having a hard outer shell made of plastic with a web support mounted in the shell to space it from the player's head. The web support was subsequently replaced with a type of shock absorbing liner or padding.

In addition to the outer shell with interior padding, the conventional football helmet includes a face guard, having either upper or lower side mounts, and a chin protector or strap, that fits snugly about the chin of the player, in order to secure the helmet to the player's head.

In contact sports such as football, helmets provide players a substantial degree of protection against injury to their heads due to impact forces that may be sustained; however, a large number of head injuries and brain concussions, particularly g-force injuries, continue to occur. Rapid acceleration or deceleration of the head (g-forces) has been deemed to be the cause of many sports-related injuries and is the subject of growing concern. When contact is made with the conventional helmet, the rigid outer shell moves as a unit, compressing the padding between the head and the shell on the contact side of the helmet. After some initial compression, the padding begins to move the head. As the entire helmet and head move away from contact, the padding begins to rebound and places increasing force on the head. This process of compressing padding while gradually imparting an increasing load to the head is the method conventional helmets use to address g-force impacts.

Despite a large number of inventions to improve the design of protective helmets, it is still very desirable to have an improved protective helmet which provides increased and universal protection from impact forces sustained by the wearer. It is further desirable to have a protective helmet that provides a reduction of g-forces in any all directions. It is also desirable to provide an improved helmet for contact sports, non-contact sports, hazardous workplaces, and industrial plants. There is still a lot of room for improvements and a huge demand for better protective helmets that this invention provides.

### SUMMARY OF THE INVENTION

The present application discloses a multi layer protective helmet comprising one hard shell (or two joined hard shells) and an energy absorbing layers. The shell (or outer shell) includes a crown portion, a front portion, a left side portion, a right side portion, and a rear portion, wherein each side portion has an ear flap with an ear opening, and wherein the outer shell has vent openings; and a faceguard secured to the outer shell by at least two faceguard connectors; and a chin protector with four chin strap attachments secured to the outer shell.

The shell (or the inner and outer shells) can be integrated with energy absorbing material to dampen energy received by the shell(s).

In this invention, the helmet has multi-layers of energy absorbing materials to dampen energy and reduce impacts, head injuries, and sports related concussions (SRC). Sports Related Concussions have become an international public health concern, affecting athletes of all ages in many sports especially in the American football. Therefore, there is a huge demand for better helmets to prevent or reduce head injuries throughout the World.

The material recommended for the hard shell (or shells) of the multi-layer protective helmet are: Acrylonitrile Butadiene Styrene (ABS) (Thermoplastic), Polycarbonates (Thermoplastic), Advanced Thermoset Resin (ATR), Fiberglass, Carbon Fiber, Kevlar, and Synthetic Reinforced Shell (SRS). Polycarbonates are ideal materials for helmet shells because they are lightweight, tough and exhibit good impact strength, even in extreme temperatures. Polycarbonates refer to a family of thermoset polymers that are widely used in manufacturing, for their mechanical performance and ease in manufacturing.

The material recommended for the energy-absorbing layers as of today's technology is the Sorbothane 70 Durometer, where Durometer is a unit of hardness. There is another candidate which is the Dow Corning 3179 Dilatant Compound. However, it was proven that Sorbothane 70 Durometer is superior to the Dow Corning 3179 Dilatant Compound in both force reduction and recovery from impact without any deformation. Future technologies may give us better energy absorbing materials.

The invented helmet complies with the National Football League (NFL) design constraints to achieve a high level of protection due to the severity of the American football, and to make the invented helmet wearable by the NFL players.

### BRIEF DESCRIPTION OF THE DRAWINGS

A better understanding of the present invention can be obtained when the following detailed description of the disclosed preferred embodiments is considered in conjunction with the following drawings, in which:

FIG. 1 is an example for a top view of a protective helmet wherein the shell is integrated with energy absorbing material spaced within the structure of the shell;

FIG. 2 is a second example of a top view of a protective helmet wherein the shell is integrated with energy absorbing material spaced within the structure of the shell;

FIG. 3 is a cross-sectional view of a protective helmet showing the shell integrated with energy absorbing material spaced within the structure of the shell and an inner energy absorbing layer;

FIG. 4 is a cross-sectional view of a protective helmet showing the shell integrated with energy absorbing material spaced within the structure of the shell and two inner energy absorbing layers using two different energy absorbing materials;

FIG. 5 is a cross-sectional view of the protective helmet showing the shell and outer energy absorbing layer and inner energy absorbing layer;

FIG. 6 is a cross-sectional view of a protective helmet showing the shell integrated with energy absorbing material spaced within the structure of the shell, and outer energy absorbing layer and inner energy absorbing layer;

FIG. 7 is a cross-sectional view of the protective helmet showing the shell and inner energy absorbing layer, and outer energy absorbing layer outer layer compromising of hair-like layer whereas each hair represents a spring-like element capable of deforming when force is applied then returning to its state prior to application of the force to dampen the impact energy;

FIG. 8 is a cross-sectional view of a protective helmet showing the shell integrated with energy absorbing material spaced within the structure of the shell, and inner energy absorbing layer, and outer energy absorbing layer outer layer compromising of hair-like layer whereas each hair represents a spring-like element capable of deforming when force is applied then returning to its state prior to application of the force to dampen the impact energy;

FIG. 9 is a cross-sectional view of a protective helmet with two shells, inner shell and outer shell, and energy absorbing layer here between, and outer energy absorbing layer coupled to the outer surface of the outer shell, and inner energy absorbing layer coupled to the inner surface of the inner shell;

FIG. 10 is a cross-sectional view of a protective helmet with two shells, inner shell and outer shell, and energy absorbing layer here between, and inner energy absorbing layer coupled to the inner surface of the inner shell, and outer energy absorbing layer coupled to the outer surface of the outer shell layer compromising of hair-like layer whereas each hair represents a spring-like element capable of deforming when force is applied then returning to its state prior to application of the force to dampen the impact energy;

FIG. 11 is a cross-sectional view of a protective helmet with two shells, inner shell and outer shell wherein the inner shell is integrated with energy absorbing material spaced within the structure of the inner shell, and energy absorbing layer therebetween, and outer energy absorbing layer coupled to the outer surface of the outer shell, and inner energy absorbing layer coupled to the inner surface of the inner shell;

FIG. 12 is a cross-sectional view of a protective helmet with two shells, inner shell and outer shell wherein the inner shell is integrated with energy absorbing material spaced within the structure of the inner shell, and energy absorbing layer therebetween, and outer energy absorbing layer coupled to the outer surface of the outer shell, and inner energy absorbing layer coupled to the inner surface of the inner shell;

FIG. 13 is a cross-sectional view of a protective helmet with two shells, inner shell and outer shell wherein the outer and inner shells are integrated with energy absorbing material spaced within the structure of each shell, and energy absorbing layer therebetween, and outer energy absorbing layer coupled to the outer surface of the outer shell, and inner energy absorbing layer coupled to the inner surface of the inner shell;

FIG. 14 is a cross-sectional view of a protective helmet with two shells, inner shell and outer shell wherein the inner shell is integrated with energy absorbing material spaced within the structure of the inner shell, and energy absorbing layer therebetween, and outer energy absorbing layer coupled to the outer surface of the outer shell compromising of hair-like layer whereas each hair represents a spring-like element capable of deforming when force is applied then returning to its state prior to application of the force to dampen the impact energy, and inner energy absorbing layer coupled to the inner surface of the inner shell;

FIG. 15 is a cross-sectional view of a protective helmet with two shells, inner shell and outer shell wherein the inner shell is integrated with energy absorbing material spaced within the structure of the inner shell, and energy absorbing layer therebetween, and outer energy absorbing layer coupled to the outer surface of the outer shell compromising of hair-like layer whereas each hair represents a spring-like element capable of deforming when force is applied then returning to its state prior to application of the force to dampen the impact energy, and inner energy absorbing layer coupled to the inner surface of the inner shell; and

FIG. 16 is a cross-sectional view of a protective helmet with two shells, inner shell and outer shell wherein the outer and inner shells are integrated with energy absorbing material spaced within the structure of each shell, and energy absorbing layer therebetween, and outer energy absorbing layer coupled to the outer surface of the outer shell compromising of hair-like layer whereas each hair represents a spring-like element capable of deforming when force is applied then returning to its state prior to application of the force to dampen the impact energy, and inner energy absorbing layer coupled to the inner surface of the inner shell.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

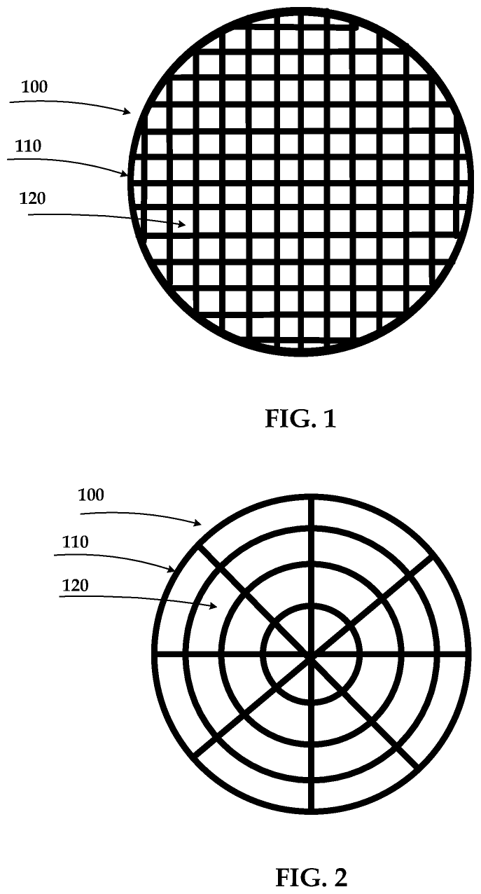

Referring now to the drawings, in which like reference numerals are used to refer to identical or similar elements, a first preferred embodiment of the multi layer protective helmet, generally referred to as reference numeral 100, is shown in FIG. 1 to FIG. 16.

FIG. 1 gives an example of a top view of the partial helmet 100 with the shell 110 integrated with energy absorbing material 120 spaced within the structure of the shell 110. It is recommended that the hard shell 110 is made of very hard and lightweight material such as Acrylonitrile Butadiene Styrene (ABS) (Thermoplastic), Polycarbonates (Thermoplastic), Advanced Thermoset Resin (ATR), Fiberglass, Carbon Fiber, Kevlar, and Synthetic Reinforced Shell (SRS). While, the energy absorbing material 120 is made of Dow Corning 3179 Dilatant Compound which absorb energy and gets harder upon impact. FIG. 2 represents another example of the top view of the partial helmet 100 with the hard shell 110 integrated with energy absorbing material 120 spaced within the structure of the shell 110. Numerous patterns and examples for a shell 110 integrated with energy-absorbing material 120 can be generated to serve the same purpose of reducing and absorbing energy received by the shell upon impact.

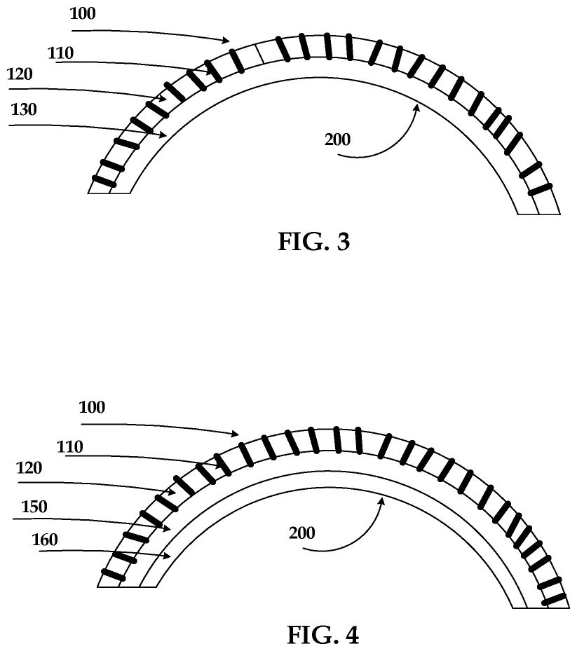

Referring to preferred embodiment of FIG. 3, which is a cross-sectional view of FIG. 1 or FIG. 2, the shell 110 integrated with energy absorbing material 120 is coupled to an inner layer 130 of another energy absorbing material. It is recommended that material used for the inner layer 130 is Sorbothane 70 Durometer which absorbs energy and gets softer upon impact. The outer surface 200 of the inner layer 130 having a contoured structure to conform to the general outline of a wearer's head for added comfort. Alternatively, internal padding (not shown) coupled to the outer surface 200 of the inner layer 130 can be used to conform to the general outline of a wearer's head. Internal padding may comprise a plurality of pads located within the inner layer 130 adapted to contact various portions of the wearer's head, such as the forehead, temples, ears, jaw, crown and back of the head, as is well known to those skilled in the art. Typical utilized padding materials include foam padding, as for example polyurethane foam, rubber foam and PVC Nitrile foam. Additionally, the internal padding may include an upper suspension system comprising a fully enclosed fluid suspension system that encompasses the entire circumference of the upper head. As compression occurs, the fluid, typically air, is forced out of a controlled air valve, and then filled back with air after impact. Such systems are conventional and well known to those skilled in the art. Preferably, the padding including the air impact cell system for the helmet 100 is a medical grade polymer such as thermoplastic urethane (“TPU”). Thus, the padding and air impact cell system is antifungal and will not freeze, harden, melt, crack, or leak.

In the preferred embodiment of FIG. 4, is a partial cross-sectional view of a protective helmet 100 showing the shell 110 integrated with energy absorbing material 120 spaced within the structure of the shell and two inner energy absorbing layers 150 and 160 using two different energy absorbing materials. It is recommended that Sorbothane 70 Durometer is used for the inner layer 160, and Dow Corning 3179 Dilatant Compound is sued for the integrated energy absorbing material 120 and the inner layer 150. The outer surface 200 of the inner layer 160 having a contoured structure to conform to the general outline of a wearer's head for added safety and comfort. Alternatively, internal padding (not shown) coupled to the outer surface 200 of the inner layer 160 can be used to conform to the general outline of a wearer's head.

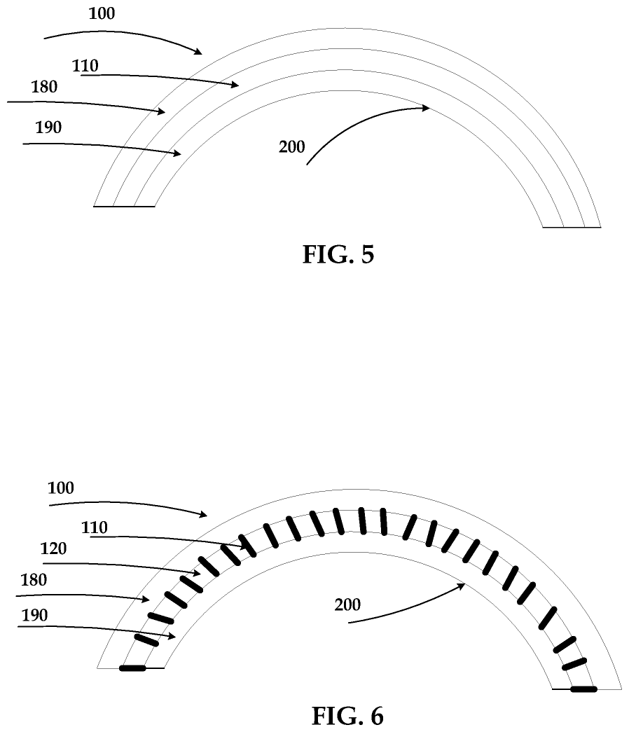

Referring to FIG. 5, it shows a partial cross-sectional view of a protective helmet 100 showing the shell 110, and outer layer of energy absorbing material 180 coupled to the outer surface of the shell and inner layer of energy absorbing material 190 coupled to the inner surface of the shell. It is recommended that Sorbothane 70 Durometer is used for both the outer layer 180 and the inner layer 190. The outer surface 200 of the inner layer 190 is having a contoured structure to conform to the general outline of a wearer's head for added safety and comfort. Alternatively, internal padding (not shown) coupled to the outer surface 200 of the inner layer 190 can be used to conform to the general outline of a wearer's head.

The preferred embodiment of FIG. 6 shows a partial cross-sectional view of a protective helmet 100 showing the shell 110 integrated with energy absorbing material 120 spaced within the structure of the shell 110, and outer layer of energy absorbing material 180 coupled to the outer surface of the shell and inner layer of energy absorbing material 190 coupled to the inner surface of the shell. It is recommended that Sorbothane 70 Durometer is used for both the outer layer 180 and the inner layer 190, while the Dow Corning 3179 Dilatant Compound is recommended for the energy absorbing material 120. The outer surface 200 of the inner layer 190 is having a contoured structure to conform to the general outline of a wearer's head for added safety and comfort. Alternatively, internal padding (not shown) coupled to the outer surface 200 of the inner layer 190 can be used to conform to the general outline of a wearer's head.

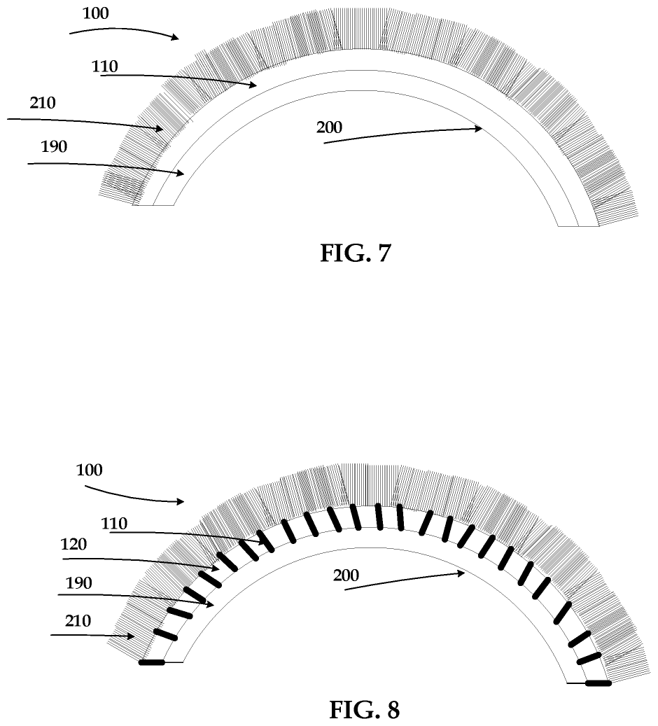

Referring to FIG. 7, it shows a partial cross-sectional view of a protective helmet 100 showing the shell 110, and outer hair-like layer of energy absorbing material 210 coupled to the outer surface of the shell and inner layer of energy absorbing material 190 coupled to the inner surface of the shell. It is recommended that Sorbothane 70 Durometer is used for both the outer layer 210 and the inner layer 190. The outer surface 200 of the inner layer 190 is having a contoured structure to conform to the general outline of a wearer's head for added safety and comfort. Alternatively, internal padding (not shown) coupled to the outer surface 200 of the inner layer 190 can be used to conform to the general outline of a wearer's head.

The preferred embodiment of FIG. 8 shows a partial cross-sectional view of a protective helmet 100 showing the shell 110 integrated with energy absorbing material 120 spaced within the structure of the shell 110, and outer hair-like layer of energy absorbing material 210 coupled to the outer surface of the shell and inner layer of energy absorbing material 190 coupled to the inner surface of the shell. It is recommended that Sorbothane 70 Durometer is used for both the outer layer 180 and the inner layer 190, while the Dow Corning 3179 Dilatant Compound is recommended for the energy absorbing material 120. The outer surface 200 of the inner layer 190 is having a contoured structure to conform to the general outline of a wearer's head for added safety and comfort. Alternatively, internal padding (not shown) coupled to the outer surface 200 of the inner layer 190 can be used to conform to the general outline of a wearer's head.

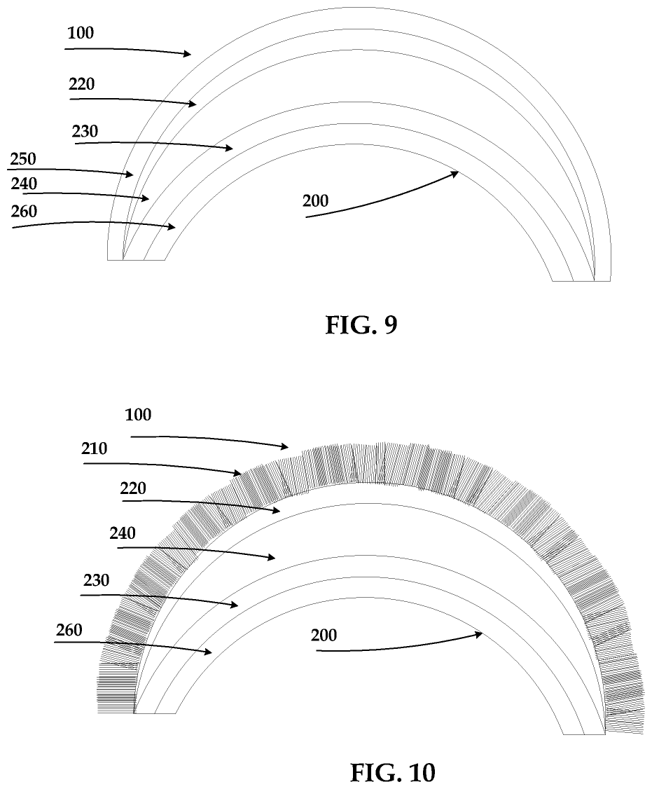

FIG. 9 shows another preferred embodiment for a multi layer protective helmet 100 comprising: an inner shell 230 with inner surface and outer shell 220; the outer shell 220 disposed on the outer surface of the inner shell 230 and fixedly joined to the outer surface of the inner shell 230; the outer shell 220 adapted to cover the inner shell 230, said outer shell having an inner surface and an outer surface; wherein energy absorbing layer 240 coupled to the outer surface of the inner shell 230 and coupled to the inner surface of the outer shell 220; and an outer energy absorbing layer 250 coupled to the outer surface of the outer shell 220; and an inner energy absorbing layer 260 coupled to the inner surface of the inner shell 230; said inner layer having a contoured member 200 to conform to the general outline of a wearer's head. Alternatively, internal padding (not shown) coupled to the outer surface 200 of the inner energy absorbing layer 260 can be used to conform to the general outline of a wearer's head.

The preferred embodiment of FIG. 10 shows a multi layer protective helmet 100 comprising: an inner shell 230 with inner surface and outer surface; an outer shell 220 disposed on the outer surface of the inner shell and fixedly joined to the outer surface of the inner shell 230; the outer shell 220 adapted to cover the inner shell 230, said outer shell having an inner surface and an outer surface; wherein energy absorbing layer 240 coupled to the outer surface of the inner shell 230 and coupled to the inner surface of the outer shell 220; and an outer energy absorbing hair-like layer 210 coupled to the outer surface of the outer shell 220; and an inner energy absorbing layer 260 coupled to the inner surface of the inner shell 230; said inner energy absorbing layer 260 having a contoured member 200 to conform to the general outline of a wearer's head. Alternatively, internal padding (not shown) coupled to the outer surface 200 of the inner energy absorbing layer 260 can be used to conform to the general outline of a wearer's head.

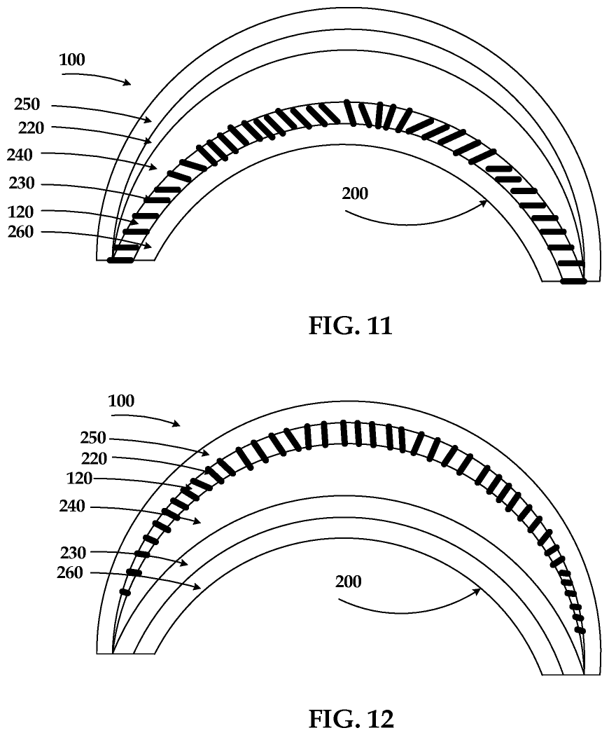

FIG. 11 shows another preferred embodiment for a multi layer protective helmet 100 comprising: an inner shell 230 integrated with energy absorbing material 120 spaced within the structure of the inner shell 230, wherein the inner shell 230 has inner surface and outer surface; an outer shell 220 disposed on the outer surface of the inner shell 230 and fixedly joined to the outer surface of the inner shell 230; the outer shell 220 adapted to cover the inner shell 230, said outer shell having an inner surface and an outer surface; wherein energy absorbing layer 240 coupled to the outer surface of the inner shell 230 and coupled to the inner surface of the outer shell 220; and an outer energy absorbing layer 250 coupled to the outer surface of the outer shell 220; and an inner energy absorbing layer 260 coupled to the inner surface of the inner shell 230; said inner layer having a contoured member 200 to conform to the general outline of a wearer's head. Alternatively, internal padding (not shown) coupled to the outer surface 200 of the inner energy absorbing layer 260 can be used to conform to the general outline of a wearer's head.

Another preferred embodiment is shown in FIG. 12 for a multi layer protective helmet 100 comprising: an inner shell 230 with inner surface and outer surface; an outer shell 220 disposed on the outer surface of the inner shell and fixedly joined to the outer surface of the inner shell 230; the outer shell 220 adapted to cover the inner shell 230, said outer shell 220 having an inner surface and an outer surface. The outer shell 220 is integrated with energy absorbing material 120 spaced within the structure of the outer shell 220; wherein energy absorbing layer 240 coupled to the outer surface of the inner shell 230 and coupled to the inner surface of the outer shell 220; and an outer energy absorbing layer 250 coupled to the outer surface of the outer shell 220; and an inner energy absorbing layer 260 coupled to the inner surface of the inner shell 230; said inner layer having a contoured member 200 to conform to the general outline of a wearer's head. Alternatively, internal padding (not shown) coupled to the outer surface 200 of the inner energy absorbing layer 260 can be used to conform to the general outline of a wearer's head.

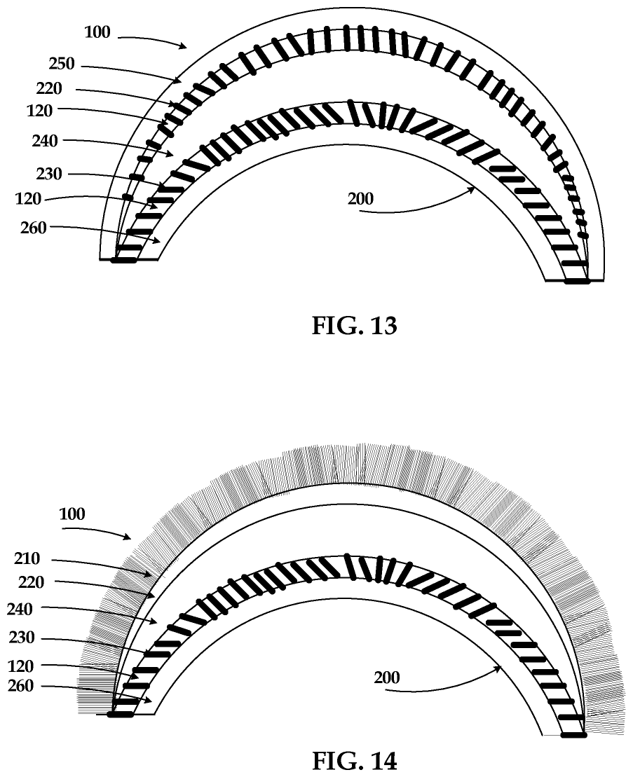

FIG. 13 shows another preferred embodiment for a multi layer protective helmet 100 comprising: an inner shell 230 integrated with energy absorbing material 120 spaced within the structure of the inner shell 230, wherein the inner shell 230 has inner surface and outer surface; an outer shell 220 disposed on the outer surface of the inner shell 230 and fixedly joined to the outer surface of the inner shell 230; The outer shell 220 is integrated with energy absorbing material 120 spaced within the structure of the outer shell 220. The outer shell 220 adapted to cover the inner shell 230, said outer shell having an inner surface and an outer surface; wherein energy absorbing layer 240 coupled to the outer surface of the inner shell 230 and coupled to the inner surface of the outer shell 220; and an outer energy absorbing layer 250 coupled to the outer surface of the outer shell 220; and an inner energy absorbing layer 260 coupled to the inner surface of the inner shell 230; said inner layer having a contoured member 200 to conform to the general outline of a wearer's head. Alternatively, internal padding (not shown) coupled to the outer surface 200 of the inner energy absorbing layer 260 can be used to conform to the general outline of a wearer's head.

FIG. 14 shows another preferred embodiment for a multi layer protective helmet 100 comprising: an inner shell 230 integrated with energy absorbing material 120 spaced within the structure of the inner shell 230, wherein the inner shell 230 has inner surface and outer surface; an outer shell 220 disposed on the outer surface of the inner shell 230 and fixedly joined to the outer surface of the inner shell 230; the outer shell 220 adapted to cover the inner shell 230, said outer shell having an inner surface and an outer surface; wherein energy absorbing layer 240 coupled to the outer surface of the inner shell 230 and coupled to the inner surface of the outer shell 220; and an outer energy hair-like energy absorbing layer 210 coupled to the outer surface of the outer shell 220; and an inner energy absorbing layer 260 coupled to the inner surface of the inner shell 230; said inner layer having a contoured member 200 to conform to the general outline of a wearer's head. Alternatively, internal padding (not shown) coupled to the outer surface 200 of the inner energy absorbing layer 260 can be used to conform to the general outline of a wearer's head.

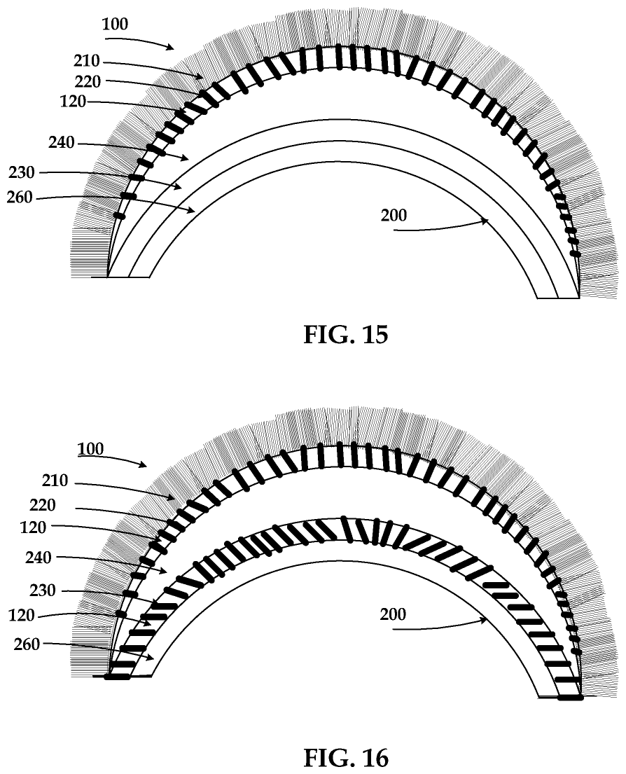

Another preferred embodiment is shown in FIG. 15 for a multi layer protective helmet 100 comprising: an inner shell 230 with inner surface and outer surface; an outer shell 220 disposed on the outer surface of the inner shell and fixedly joined to the outer surface of the inner shell 230; the outer shell 220 adapted to cover the inner shell 230, said outer shell 220 having an inner surface and an outer surface. The outer shell 220 is integrated with energy absorbing material 120 spaced within the structure of the outer shell 220; wherein energy absorbing layer 240 coupled to the outer surface of the inner shell 230 and coupled to the inner surface of the outer shell 220; and hair-like energy absorbing layer 210 coupled to the outer surface of the outer shell 220; and an inner energy absorbing layer 260 coupled to the inner surface of the inner shell 230; said inner layer having a contoured member 200 to conform to the general outline of a wearer's head. Alternatively, internal padding (not shown) coupled to the outer surface 200 of the inner energy absorbing layer 260 can be used to conform to the general outline of a wearer's head.

FIG. 16 shows another preferred embodiment for a multi layer protective helmet 100 comprising: an inner shell 230 integrated with energy absorbing material 120 spaced within the structure of the inner shell 230, wherein the inner shell 230 has inner surface and outer surface; an outer shell 220 disposed on the outer surface of the inner shell 230 and fixedly joined to the outer surface of the inner shell 230; The outer shell 220 is integrated with energy absorbing material 120 spaced within the structure of the outer shell 220. The outer shell 220 adapted to cover the inner shell 230, said outer shell having an inner surface and an outer surface; wherein energy absorbing layer 240 coupled to the outer surface of the inner shell 230 and coupled to the inner surface of the outer shell 220; and an outer hair-like energy absorbing layer 210 coupled to the outer surface of the outer shell 220; and an inner energy absorbing layer 260 coupled to the inner surface of the inner shell 230; said inner layer having a contoured member 200 to conform to the general outline of a wearer's head. Alternatively, internal padding (not shown) coupled to the outer surface 200 of the inner energy absorbing layer 260 can be used to conform to the general outline of a wearer's head.

Although not shown, it is also to be understood that the protective helmet 100 may include such features that are well known and understood to those skilled in the art including a chin protector with a chin strap, a plurality of air vents located through the front, top, and back of the helmet 100 to allow for maximum air flow and to circulate the inside helmet air through the air vents, and in certain activities such as football, a face guard system is required to protect the player's face from any impact at the front of the helmet. Face guards and attachment devices for attaching the face guard to the helmet shell are well known to those skilled in the art. Face guards and attachment devices for attaching the face guard to the helmet shell are well known to those skilled in the art. A face guard system including a wire face guard, preferably made from steel, such as stainless or titanium, and covered by plastic, such as a powder coated plastic. The face guard is preferably pivotally attached to the upper front (forehead) portion of the helmet 100 with fasteners, typically screws, as are well known in the art.

It is the desire that the protective helmet of the present invention provides a degree of protection to its wearer by reducing the g-forces to the head upon impact. It is to be understood that dimensions, surface forms, and internal padding can be changed to accommodate enhanced protection, thus providing safer operation of the helmet. The protective helmet can also be used for various other sports and activities not mentioned previously including, but not limited to, skiing, auto racing, and military impact training exercises.

While there have been described above the principles of this invention in connection with specific apparatus, it is to be clearly understood that this description is made only by way of example and not as a limitation to the scope of the invention. Therefore, it should be apparent that the foregoing relates only to the preferred embodiments of the present invention and that numerous changes and modifications may be made herein without departing from the spirit and the scope of the invention as defined by the following claims and equivalents thereof.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Thus the scope of the invention should be determined by the appended claims and their legal equivalents, rather than by the examples given.

While the invention has been described in detail above with reference to specific embodiments, it will be understood that modifications and alterations in the embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

I claim:

1. A multi layer protective helmet comprising:
a shell with inner surface and outer surface;
and at least one outer energy absorbing layer coupled to the outer surface of said shell wherein the outermost energy absorbing layer compromising of hair-like layer whereas each hair represents a spring-like element capable of deforming when force is applied then returning to its state prior to application of the force to dampen the impact energy;
and at least one inner energy absorbing layer coupled to the inner surface of said shell wherein the innermost energy absorbing layer having a contoured member to conform to the general outline of a wearer's head, wherein the inner energy absorbing material capable of deforming when force is applied then returning to its state prior to application of the force to dampen the impact energy.

2. The multi layer protective helmet of claim 1, wherein the shell is a hard shell.

3. The multi layer protective helmet of claim 2, wherein the shell is integrated with energy absorbing material spaced within the structure of the shell, wherein the energy absorbing material capable of deforming when force is applied then returning to its state prior to application of the force to dampen the impact of energy.

4. A multi layer protective helmet comprising:
an inner shell with inner surface and outer surface;
and an outer shell with inner surface and outer surface disposed on the outer surface of the inner shell and fixedly joined to the outer surface of the inner shell wherein outer shell adopted to cover the inner shell and wherein energy absorbing layer coupled to the outer surface of the inner shell and coupled to the inner surface of the outer shell;
and at least one outer energy absorbing layer coupled to the outer surface of the outer shell wherein the outermost energy absorbing layer compromising of hair-like layer whereas each hair represents a spring-like element capable of deforming when force is applied then returning to its state prior to application of the force to dampen the impact energy;
and at least one inner energy absorbing layer coupled to the inner surface of the inner shell wherein the innermost energy absorbing layer having a contoured member to conform to the general outline of a wearer's head, wherein the energy absorbing material capable of deforming when force is applied then returning to its state prior to application of the force to dampen the impact energy.

5. The multi layer protective helmet of claim 4, wherein the inner shell is a hard shell; and wherein the outer shell is a hard shell.

6. The multi layer protective helmet of claim 5, wherein the inner shell is integrated with energy absorbing material spaced within the structure of the inner shell capable of deforming when force is applied then returning to its state prior to application of the force to dampen the impact of energy received by the inner shell; and wherein the outer shell is integrated with energy absorbing material spaced within the structure of the outer shell capable of deforming when force is applied then returning to its state prior to application of the force to dampen the impact of energy received by the outer shell.

7. The multi layer protective helmet of claim 5, wherein the inner shell is integrated with energy absorbing material spaced within the structure of the inner shell capable of deforming when force is applied then returning to its state prior to application of the force to dampen the impact of energy received by the inner shell.

8. The multi layer protective helmet of claim 5, wherein the outer shell is integrated with energy absorbing material spaced within the structure of the outer shell capable of deforming when force is applied then returning to its state prior to application of the force to dampen the impact of energy received by the outer shell.

9. A multi layer protective helmet comprising:
a shell with inner surface and outer surface wherein the shell is a hard shell and wherein the shell is integrated with energy absorbing material spaced within the structure of the shell, wherein said energy absorbing material capable of deforming when force is applied then returning to its state prior to application of the force to dampen the impact energy;
and at least one outer energy absorbing layer coupled to the outer surface of said shell wherein the outermost energy absorbing layer compromising of hair-like layer whereas each hair represents a spring-like element capable of deforming when force is applied then returning to its state prior to application of the force to dampen the impact energy;
and at least one inner energy absorbing layer coupled to the inner surface of said shell, wherein the innermost energy absorbing layer having a contoured member to conform to the general outline of a wearer's head, wherein the energy absorbing material capable of deforming when force is applied then returning to its state prior to application of the force to dampen the impact energy.
